(19) United States
(12) Patent Application Publication
(10) Pub. No.: US 2026/0172963 A1
(43) Pub. Date: Jun. 18, 2026

(54) SEGMENTATION CAPABILITY FOR UPLINK DATA TRANSMISSIONS FROM AMBIENT POWER DEVICES

(71) Applicant: HUAWEI TECHNOLOGIES CO., LTD., SHENZHEN (CN)

(72) Inventors: Mahmoud HASABELNABY, Kanata (CA); Osama ABOUL-MAGD, Kanata (CA); Jung Hoon SUH, Kanata (CA); Yan XIN, Kanata (CA); Sara NOROUZI, Kanata (CA)

(73) Assignee: HUAWEI TECHNOLOGIES CO., LTD., SHENZHEN (CN)

(21) Appl. No.: 18/984,408

(22) Filed: Dec. 17, 2024

(51) Int. Cl. H04W 52/02; H04W 72/04

(52) U.S. Cl. CPC H04W 52/0229; H04W 52/0261; H04W 72/04

(57) ABSTRACT

Methods and apparatus for segmenting uplink transmissions by ambient-power (AMP) devices are provided. In embodiments, data collected by an AMP device is divided into segments, which are transmitted according to the energy available to the AMP device and the resources allocated by a receiving network access point. The AMP device can signal to the access point its current energy availability and the segmentation of the data by setting specific fields in the data frames used to transmit the data segments. In embodiments, a wake-up radio frame is used to transmit the data and the medium access control header thereof is used to communicate segmentation and energy information. In addition, the access point can infer whether the resources that it is allocating to the AMP device are sufficient according to this information. Embodiments can enable AMP devices to avoid deferring data transmissions and consuming power unnecessarily.

### CROSS-REFERENCE TO RELATED APPLICATIONS

This is the first application filed for the present invention.

### FIELD OF THE INVENTION

The present application pertains to communication networks and in particular to methods and apparatus for transmitting data from ambient power devices.

### BACKGROUND

Internet-of-things (IoT) networks operating under wireless Wi-Fi protocols have seen widespread deployment. Features such as utilization of an unlicensed frequency band for communications has made these networks attractive for a range of applications. However, Wi-Fi IoT technologies cannot meet the needs of all situations. For example, IoT devices powered by conventional batteries may not be suitable for deployment in certain environments, such as those with high pressures, extreme temperatures, or humidity. They may also not be suitable for situations where maintenance-free devices are required, such as when battery replacement is not possible. In some other situations, there may be requirements for devices to be ultra-low complexity or small, such as with a thickness of millimeters, which existing Wi-Fi IoT technologies may not meet.

Ambient power (AMP) devices represent a new generation of IoT devices. These devices operate on energy harvested from ambient power sources, such as radio waves, solar power, heat, motion, and vibrations. This can eliminate the need for the device to have a conventional battery. AMP devices are typically characterized by ultra-low power consumption, which can peak below 1 mW and can be due to a low density of ambient power. AMP devices can further be small and sufficiently simple for cost-effective deployment in most applications. In addition, they can be compatible with legacy infrastructure.

In order for AMP devices to perform their intended functions, they must be able to gather sufficient energy from their surroundings. Functions can, for example, include collecting data, recording measurements, retaining memory, and transmitting data to a network. These functions consume the energy harvested by the device, which must be replenished once a certain amount is used in order for the device to continue functioning.

Standards for radio-frequency identification (RFID) tags and the IEEE 802.11ah wireless networking protocol have served as foundational references for guiding the deployment of AMP devices, especially towards data transmission and resource allocation for IoT and sensor-enabled devices. Communications between RFID readers and tags, as well as between access points (APs) and associated IoT stations (STAs) under the 802.11ah protocol, have not typically supported data packet segmentation and reassembly.

In RFID systems, communication between an RFID reader and a tag is typically brief and designed for rapid data exchanges. The reader may query the tag for its unique identifier, and depending on the tag's memory capacity and type (e.g., passive, semi-passive, or active), the reader may read or write small blocks of data. RFID systems do not typically support data packet segmentation or reassembly because they are usually focused on transmitting small, self-contained amounts of data in a single transmission. This design is suitable for short, isolated interactions, such as in inventory management, identification, and access control, where larger or fragmented data packets are not typically needed.

Meanwhile, the IEEE 802.11ah standard was specifically developed to provide low-power, long-range communication for a massive number of IoT devices in wireless local area networks (WLANs). The standard was not designed to accommodate AMP devices, as it assumes that the IoT devices (STAs) are powered by a battery or a stable power source. The 802.11ah standard introduces mechanisms like the Restricted Access Window (RAW), which helps manage network congestion by allocating specific timeslots for STAs to transmit data. An STA may only initiate frame transmission if the remaining time in the assigned RAW slot is greater than or equal to the time required to complete both the transmission of the frame and the reception of an expected immediate response from a peer medium access control (MAC) entity (e.g., the AP). If the remaining RAW timeslot is insufficient, even if the timeslot is not completely exhausted, the STA may be prohibited from initiating transmission. This mechanism is intended to prevent incomplete transmissions, which can lead to data losses or inefficiency. Like RFID systems, the IEEE 802.11ah standard does not support data packet segmentation and reassembly.

AMP devices or STAs, especially battery-less AMP STAs, may have operational constraints that prevent the transmission of data entirely within a single transmission. The energy harvested by an AMP STA or resources allocated by the AP, such as the duration of a timeslot, may not be sufficient to complete the transmission of an entire data packet. In such cases, the device would be forced to delay the transmission until the next timeslot, which may introduce inefficiency and increase latency. In a first scenario, an AMP STA may have a need to transmit data that has been collected and stored in its memory and although the uplink resource allocation (e.g., timeslot duration) provided by an AP may be sufficient to complete the entire transmission, the remaining energy at the AMP STA may be only enough to send a portion of the data. This scenario may be common for AMP STAs that rely on harvested or ambient energy sources that may not provide consistent or adequate power. As a result, the AMP STA may be forced to defer transmission until it can accumulate enough energy to complete the entire process. Alternatively, in another scenario, the AMP STA may have accumulated enough energy to send all its stored data, but the uplink resource allocation from the AP, such as the duration of a provided timeslot, may be insufficient to allow for a full transmission. In this situation, the AMP STA may need to delay its transmission until it receives a larger timeslot or more resources in subsequent communication opportunities. Although the AMP STA has adequate energy, the resource constraints imposed by the AP may prevent timely data transmission. In both scenarios, the AMP STA may be forced to retain its uplink data in memory and defer transmission until it either accumulates enough energy or receives sufficient resources to send the entire data in a single transaction.

Deferring a transmission can be detrimental to the operation of the AMP STA. Holding data in the AMP STA's memory for extended periods can significantly increase its operational power consumption. Memory operations, especially those involving retention of large amounts of data, consume energy, which may already be a scarce resource for the AMP STA. Over time, this can reduce the overall efficiency of the AMP STA and limit its ability to perform other essential functions, such as data collection or communication. AMP STAs often have limited memory capacity, which restricts the amount of data that they can store. To delay a transmission, data may need to remain in memory for a longer period, reducing the memory space available for storing new incoming data. This can lead to memory overflows, where the AMP STA may be unable to collect additional sensor data, thereby limiting the overall functionality of the device. Furthermore, deferring a transmission, can add latency. This can be particularly detrimental to situations involving delay-sensitive data. Many AMP STAs are used in IoT applications where real-time or near-real-time data transmission is crucial. Such applications can include an AMP STA collecting sensor data from environmental monitoring systems, health monitoring devices, or industrial applications, where delays in transmitting this data can severely impact system performance. For example, in wearable devices or health monitoring systems, sensors may collect vital signs such as heart rate, temperature, or oxygen levels, which may need to be transmitted promptly to healthcare providers to prevent declines in patient health. In applications such as air quality or weather monitoring, AMP STAs often collect real-time data that may be used for immediate decision-making. Delays in transmitting this data can impact the ability to provide timely alerts or responses, particularly in cases of hazardous environmental conditions (e.g., smoke detection, gas leaks, or temperature fluctuations), where immediate communication may be needed to prevent harm. In industrial environments, AMP STAs may monitor critical systems such as machinery or infrastructure to prevent equipment failure or optimize performance. Delays in these environments could result in downtime, reduced efficiency, or even safety hazards.

Deferring a transmission can also be detrimental to the operation of a network hosting the AMP STA. Delayed or incomplete transmissions can lead to overall inefficiencies in the network. Because AMP STAs must wait for either more energy to be harvested or additional resources to be allocated, the transmission process becomes unpredictable, increasing congestion and reducing the throughput of the network. This may cause an AP to underutilize its allocated resources and can lead to wasted network capacity. For networks with many AMP STAs, such as thousands of AMP STAs, this problem can compound and lead to network congestion and erratic transmission patterns. For applications that require high-quality, reliable, and timely data transmission, the inability of AMP STAs to transmit data in segments may severely affect the quality-of-service (QoS) for a system overall. Many IoT applications require strict adherence to latency and bandwidth requirements, which when unmet may manifest as unreliability and reduced performance in the system, thereby affecting end-user experiences or mission-critical tasks.

Therefore, there is a need for methods and apparatus for segmenting AMP uplink data transmissions that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide methods and apparatus for segmenting uplink data transmissions from an AMP STA.

A first aspect of the present disclosure is to provide a method for transmitting data from an STA to an AP of a communications network. The method may comprising, at the STA: receiving, from the AP, a first trigger frame indicating a first resource allocation for the STA; obtaining an energy parameter indicating an energy state for the STA; dividing, in accordance with the first resource allocation and the energy state for the STA, the data into a plurality of segments; sending, to the AP, a first segment of the plurality of segments of the data in accordance with the first resource allocation; receiving, from the AP, a second trigger frame indicating a second resource allocation for the STA; and sending, to the AP, a second segment of the plurality of segments of the data in accordance with the first resource allocation.

In some embodiments of the first aspect, dividing, in accordance with the first resource allocation and the energy state for the STA, the data into the plurality of segments of the data may include segmenting, when the first resource allocation is less than a threshold allocation or when the energy state is less than a threshold energy state, the data into the plurality of segments of the data.

In some embodiments of the first aspect, the method may further comprise, at the STA, preparing a wake-up radio (WUR) frame including the first segment of the plurality of segments of the data and a MAC header, the MAC header including a type-dependent control field indicating the energy state and a segmentation state for the first segment of the plurality of segments of the data. In these embodiments, sending, to the AP, the first segment of the plurality of segments of the data in accordance with the first resource allocation may include sending, to the AP, the WUR frame in accordance with the first resource allocation. In some of these embodiments, the method may further comprise, at the STA, preparing a further WUR frame including the second segment of the plurality of segments of the data and a further MAC header, the further MAC header including a further type-dependent control field indicating a further segmentation state for the second segment of the plurality of segments of the data. In these embodiments, sending, to the AP, the second segment of the plurality of segments of the data in accordance with the second resource allocation may include sending, to the AP, the further WUR frame in accordance with the second resource allocation.

In some embodiments, the type-dependent control field may include a first set of bits and a second set of bits; and the further type-dependent control field may include a third set of bits. In these embodiments, preparing the WUR frame may include: setting the first set of bits to indicate the energy state; and setting the second set of bits to indicate the segmentation state. Preparing the further WUR frame may then include setting the third set of bits to indicate the further segmentation state. In some embodiments, the first set of bits may include two bits, setting the first set of bits to indicate the energy state may include setting the two bits to indicate an energy level. In some other embodiments, the first set of bits may include eight bits, and setting the first set of bits to indicate the energy state may include setting the eight bits to indicate either a remaining energy percentage or a remaining energy measure. In some other embodiments, each of the second set of bits and the third set of bits may include a respective two bits. In these embodiments, setting the second set of bits to indicate the segmentation state may include setting the respective two bits of the second set of bits to indicate segmentation of the data and that the first segment of the plurality of segments of the data is an initial segment, and setting the third set of bits to indicate the further segmentation state may include setting the respective two bits of the third set of bits to indicate segmentation of the data and that the second segment of the plurality of segments of the data is a final segment. In some other embodiments, each of the second set of bits and the third set of bits may include a respective one bit. In these embodiments, setting the second set of bits to indicate the segmentation state may include setting the respective one bit of the second set of bits to indicate at least one segment of the plurality of segments of the data remains, and setting the third set of bits to indicate the further segmentation state may include setting the respective one bit of the third set of bits to indicate that all segments of the plurality of segments of the data are sent. In some other embodiments, the plurality of segments of the data may include at least three segments of the data, and each of the second set of bits and the third set of bits may include a respective two bits. In these embodiments, setting the second set of bits to indicate the segmentation state may include setting the respective two bits of the second set of bits to indicate segmentation of the data and that the first segment of the plurality of segments of the data is an initial segment, and setting the third set of bits to indicate the further segmentation state may include setting the respective two bits of the third set of bits to indicate segmentation of the data and that at least one segment of the plurality of segments of the data remains. In some other embodiments, the plurality of segments of the data may include at least three segments of the data, and each of the second set of bits and the third set of bits may include a respective three bits. In these embodiments, setting the second set of bits to indicate the segmentation state may include setting the respective three bits of the second set of bits to indicate a respective sequential position for the first segment of the plurality of segments of the data, and setting the third set of bits to indicate the further segmentation state may include setting the respective three bits of the third set of bits to indicate a respective sequential position for the second segment of the plurality of segments of the data. In still some other embodiments, the type-dependent control field may further include a fourth set of bits, and preparing the WUR frame may further include setting the fourth set of bits to indicate a local partial time synchronization function. In some of these embodiments, the method may further comprise receiving, from the AP, a beacon frame, and adjusting, in accordance with the beacon frame, a clock for the STA. In some of the preceding embodiments, setting the first set of bits to indicate the energy state may include modifying the energy state in accordance with a correction factor for anticipated transmission consumption.

In some embodiments of the first aspect, the method may further comprise, at the STA, collecting, by one or more sensors, the data.

In some embodiments of the first aspect, the method may further comprise, at the STA, generating, from one or more power sources, electrical power. In some of these embodiments, sending, to the AP, the first segment of the plurality of segments of the data in accordance with the first resource allocation may include sending, to the AP using the electrical power, the first segment of the plurality of segments of the data in accordance with the first resource allocation. In some embodiments, sending, to the AP, the second segment of the plurality of segments of the data in accordance with the second resource allocation may include sending, to the AP using the electrical power, the second segment of the plurality of segments of the data in accordance with the second resource allocation.

A second aspect of the present disclosure is to provide a method for transmitting data from a STA to a network AP. The method may comprise, at the AP: sending, to the STA, a first trigger frame indicating a first resource allocation for the STA; receiving, from the STA in accordance with the first resource allocation, a first WUR frame including a first segment of the data and a MAC header, the MAC header including a type-dependent control field indicating, for the STA, an energy state and a segmentation state for the first segment of the data, the segmentation state indicating a second segment of the data; sending, to the STA and in accordance with the segmentation state for the first segment of the data, a second trigger frame indicating a second resource allocation for the STA, the second resource allocation greater than the first resource allocation when the energy state exceeds a threshold energy state; and receiving, from the STA in accordance with the second resource allocation, a second WUR frame including the second segment of the data.

In some embodiments of the second aspect, sending, to the STA, the second trigger frame may include sending, to the STA, the second trigger frame after a time period, the time period in accordance with the energy state for the STA.

A third aspect of the present disclosure is to provide an electronic device comprising a processor coupled to tangible, non-transitory processor-readable memory. The memory may have recorded thereon data and instructions to be executed by the processor to implement a method comprising: receiving, from an AP, a first trigger frame indicating a first resource allocation for the electronic device; obtaining an energy parameter indicating an energy state for the electronic device; dividing, in accordance with the first resource allocation and the energy state for the electronic device, the data into a plurality of segments; sending, to the AP, a first segment of the plurality of segments of the data in accordance with the first resource allocation; receiving, from the AP, a second trigger frame indicating a second resource allocation for the electronic; and sending, to the AP, a second segment of the plurality of segments of the data in accordance with the second resource allocation.

Embodiments of the present disclosure may facilitate segmentation of uplink data transmissions from network STAs, especially AMP STAs. This may enable reduce or eliminate deferrals of transmissions, which may reduce power consumption, latency, and memory usage at STAs. Embodiments may further improve network efficiency and reduce congestion by improving utilization of network resources.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows an example plot of energy storage over time for an AMP device.

FIG. 2A shows a call-flow for a data uplink procedure by an AMP device, in accordance with an embodiment of the present disclosure.

FIG. 2B shows a call-flow for another data uplink procedure by an AMP device, in accordance with an embodiment of the present disclosure.

FIG. 3A shows a format for a wake-up radio (WUR) frame, in accordance with an embodiment of the present disclosure.

FIG. 3B shows a format for a MAC header, in accordance with an embodiment of the present disclosure.

FIG. 3C shows a format for a frame control field, in accordance with an embodiment of the present disclosure.

FIG. 4A shows a format for a type-dependent control field, in accordance with an embodiment of the present disclosure.

FIG. 4B shows a further format for a type-dependent control field, in accordance with an embodiment of the present disclosure.

FIG. 4C shows a further format for a type-dependent control field, in accordance with an embodiment of the present disclosure.

FIG. 5A shows a call-flow for signalling a segmentation state and an energy state, in accordance with an embodiment of the present disclosure.

FIG. 5B shows another call-flow for signalling a segmentation state and an energy state, in accordance with an embodiment of the present disclosure.

FIG. 6 shows a further format for a type-dependent control field, in accordance with an embodiment of the present disclosure.

FIG. 7 shows a further format for a type-dependent control field, in accordance with another embodiment of the present disclosure.

FIG. 8 shows a flowchart of a method for segmented data uplink by an AMP device, in accordance with an embodiment of the present disclosure.

FIG. 9 shows a flowchart of a method for allocating resources to an AMP device for transmitting segmented data, in accordance with an embodiment of the present disclosure.

FIG. 10 shows a schematic of an apparatus for segmented data transmission according to embodiments of the present disclosure.

FIG. 11 shows a schematic of an embodiment of an electronic device that may implement at least part of the methods and features of the present disclosure.

It will be noted that throughout the appended drawings, like features are identified by like reference numerals.

### DETAILED DESCRIPTION

Embodiments of the present disclosure are generally directed towards providing methods, apparatus and systems for segmenting data transmissions from an AMP device (or STA). The AMP device may, for example, be an IoT device and the data transmissions may be received by an AP of a communications network. The AMP device may be configured to obtain data, such as by collecting measurements through the use of integrated sensors, and to store the data on integrated memory. The AMP device may further be configured to harvest and store energy as electrical power from its environment, such as from solar, radio, thermal, or vibrational sources. When an AMP device receives a trigger frame from an AP that allocates resources for transmission of the AMP device's data, the AMP device may segment the data according to its current energy level and the resource allocation. If either the energy level of the AMP device or the resource allocation is foreseen to be insufficient for transmitting all the data, the AMP device may divide the data into a plurality of segments. A data frame including the first segment of the plurality of segments may be sent to the AP by way of the resource allocation. This data frame may include information on the energy level of the AMP device and an indication that the data has been segmented. In embodiments, the data frame may be formatted as a wake-up radio (WUR) frame and this information may be provided through a type-dependent control field in the MAC header of the WUR frame. The AP may then send subsequent trigger frames to the AMP device for the transmission of remaining segments of the data. Each trigger frame may allocate additional resources to the AMP device, according to whether the initial allocation was foreseen as being insufficient. The AMP device may send respective data frames for each of the remaining segments when a corresponding trigger frame is received.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The terms in each of the following sets may be considered interchangeable throughout the disclosure: AMP device, AMP STA, and STA; and remaining energy stored subfield and energy level subfield.

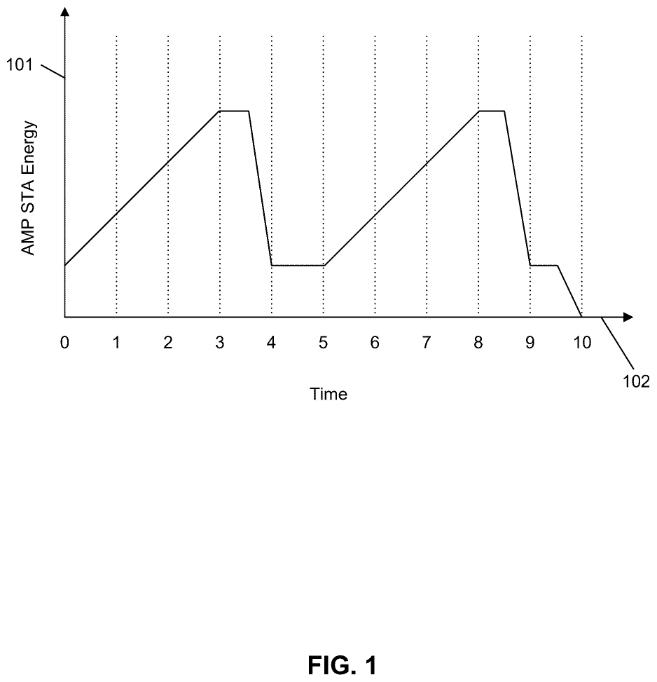

FIG. 1 shows an example plot of energy 101 for an AMP STA over time 102. In this example, the AMP STA has gathered data to be transmitted to an AP. At time 102 point 0, the AMP STA has insufficient energy 101 for transmitting its data. From time 102 points 0 to 3, the AMP STA harvests energy 101. At time 102 point 3, the AMP STA attempts to transmit the data. In this example, the AMP STA either did not harvest enough energy 101 or the resources allocated to it for the transmission were insufficient, and so not all the data was sent. The AMP STA terminates, at time 102 point 4, its transmission and begins, at time 102 point 5, harvesting energy 101 again. The AMP STA attempts, at time 102 point 6, to transmit the data again and terminates, at time point 9, the transmission because of insufficient energy 101 or resources. Here, the power source for the AMP STA becomes unavailable, and the AMP STA consumes, at time 102 point 10, its remaining energy while retaining its memory.

AMP STAs can often operate with fluctuating or limited energy resources, which can significantly impact their ability to transmit data. These devices rely on harvested energy, which may not always provide a consistent or sufficient power supply to perform tasks such as data transmission. AMP STAs can further be constrained by the resources allocated to them, such as the duration of a timeslot allocated for transmission of their data. In the example shown in FIG. 1, an insufficiency of energy or resources for the transmission causes the AMP STA to defer its transmission and to eventually lose power. In general, deference of a transmission can cause latency, which can be particularly detrimental in delay-sensitive applications, and can further cause increased power and memory consumption. In addition, deference of the transmission can result in inefficient or wasted use of network resources, erratic and unpredictable traffic patterns, reduced reliability and consistency, and congestion in the network.

Embodiments of the present disclosure may provide for reliable and efficient segmentation of uplink data at an AMP STA, in accordance with energy stored at the AMP STA and/or resources allocated by an AP. Embodiments may facilitate improvements in latency, reductions in memory and power consumption at the AMP STA, and efficiency gains in networks hosting the AMP STA.

In embodiments, the AMP STA may transmit data in smaller, segmented packets rather than wait for sufficient energy or resource allocations to transmit the entire data at once. By segmenting the data in accordance with the energy that is stored at the AMP STA and/or transmission resources allocated to the AMP STA, the AMP STA may be able to more efficiently utilize its available energy, reduce transmission delays caused by waiting for energy to be harvested, optimize its use of allocated transmission timeslots, and free up memory space as segments are transmitted.

In embodiments, the AMP STA may include information in each segmented data frame that informs the AP of its current status. This can include informing the AP on the status of data segmentation, which may include providing how much of the total data has been transmitted by the AMP STA and how much data remains in the memory of the AMP STA for subsequent transmission. It can further include informing the AP on the amount of energy that the AMP STA has stored. The segmentation and energy information, together, may enable the AP to assess whether the AMP STA is expected to be able to continue transmitting segments in subsequent timeslots and whether additional resources should be allocated to the AMP STA for transmissions. The information provided by the AMP STA can still further include a local partial time synchronization function (TSF). By providing its local partial TSF, the AMP STA may be able to receive feedback from the AP, such as by a WUR beacon frame, to ensure that an internal clock of the AMP STA remains synchronized with one of the AP. This may facilitate efficient scheduling of future transmissions and may reduce the likelihood of timing errors or miscommunication. In some embodiments, the information provided by the AMP STA may be embedded in the MAC header of the data frame.

In embodiments the AP may be able to respond adaptively to information sent to it from the AMP STA. As a first example, the AP may determine, based on the information, that the energy available to the AMP STA may be insufficient for continuing the transmission of data segments. In this case, the AP may decide to wait for the STA to harvest additional energy before allocating more resources to the AMP STA for transmission of the remaining data segments. By doing so, the AP may avoid unnecessary retransmission requests or dropped connections with the AMP STA. As a second example, the AP may determine, based on the information from the AMP STA, that the AMP STA has sufficient energy for continuing its transmissions but that the AMP STA is constrained by the resources allocated to it, such as the duration of timeslots allocated to it. In this case, the AP may decide to allocate additional resources to the AMP STA for its future transmissions, such as by extending the duration of the timeslot or by assigning a different timeslot. This may ensure that the AMP STA can complete its transmission sooner. As a third example, the AMP STA may determine, based on the information from the AMP STA, a drift in the clock of the AMP STA. If the drift exceeds a pre-determined threshold amount of drift, the AP may send to the AM STA a beacon frame with an updated TSF to ensure synchronization with the AMP STA and to ensure accuracy of the clock at the AMP STA.

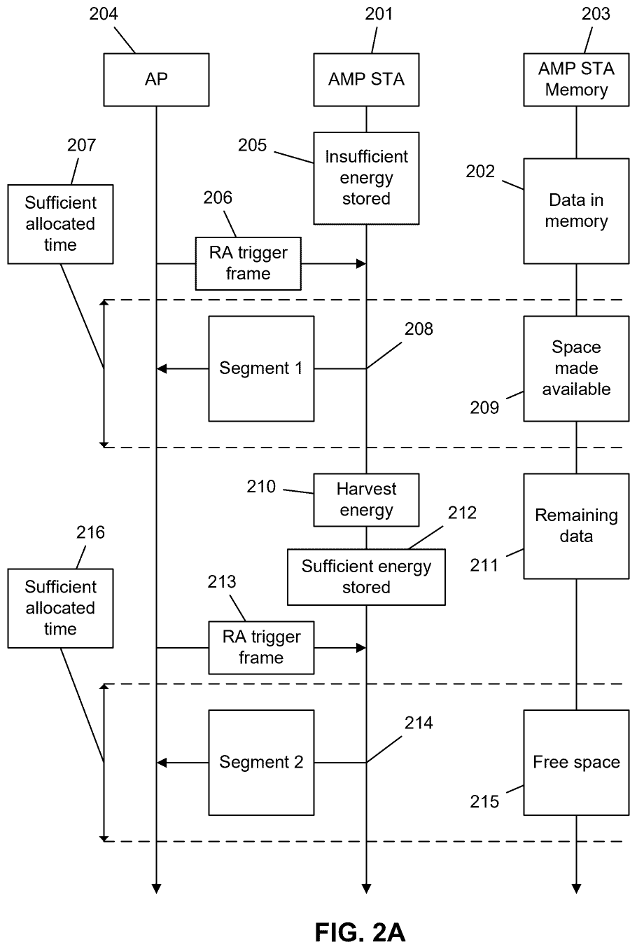

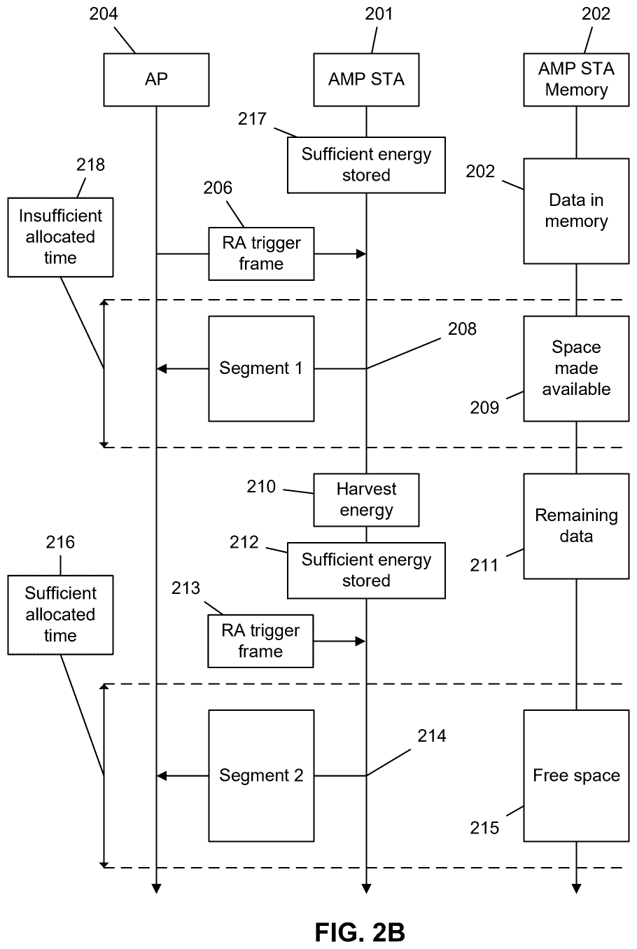

FIG. 2A shows an example of a call-flow for a procedure for segmented data transmission, in accordance with an embodiment of the present disclosure. In this example, an AMP STA 201 has obtained data 202, such as by collecting data using integrated sensors, that is stored in memory 203 integral to the AMP STA 201 and that is to be transmitted to an AP 204. The AP 204 may be a node of a communications network, through which the data 202 may be sent for delivery to a receiving network entity. The AP 204 may, for example, be an AP supporting the IEEE 802.11 protocol. Initially, the AMP STA 201 has insufficient energy stored 205 for sending all of the data 202 to the AP 204 in a single transmission. The AMP STA 201 may have harvested energy available in its surroundings, such as solar, vibrational, thermal, or radio energy. The amount of energy stored at the AMP STA 201 may be provided through an energy parameter that is obtained by the AMP STA 201, such as battery capacity or power, and may indicate an energy state for the AMP STA 201. The AP 204 may send a first resource allocation (RA) trigger frame 206 to the AMP STA 201 that indicates which resources may be allocated to the AMP STA 201 for transmission of its data 202 and for how long they may be allocated. The resource allocation may, for example, be a timeslot. In this example, the resources allocated to the AMP STA 201, particularly their duration, are sufficient 207 for transmitting all of the data 202. However, because the AMP STA 201 lacks sufficient energy to transmit all of its data 202 at once, the AMP STA 201 may divide the data 202 into a plurality of segments. In this example, the AMP STA 201 divides the data 202 into a first segment and a second segment. In accordance with the first RA trigger frame 206, the AMP STA 201 may send the first segment 208 of the data to the AP 204, which may free up 209 space in the memory 203 of the AMP STA 201. The AMP STA 201 may include information with the first segment 208 of the data, such as an indication of the energy state of the AMP STA 201 and an indication of the segmentation of the data (i.e., the segmentation state). The segmentation state may inform the AP 204 that data remains at the AMP STA 201. The AMP STA 201 may then harvest 210 more energy to prepare for transmission of the remaining data 211, i.e., the second segment. The AP 204 may, based on the received information on the energy state of the AMP STA 201, wait for the AMP STA 201 to harvest sufficient energy 212 for a subsequent transmission. Based on the received information on the segmentation of the data, the AP 204 may send a second RA trigger frame 213 to the AMP STA 201 that indicates a resource allocation for transmission of the second segment of the data. In accordance with the second RA trigger frame 213, the AMP STA 201 may send the second segment 214 of the data to the AP 204, which may further free up 215 space in the memory 203 of the AMP STA 201. The AMP STA 201 may include information with the second segment 208 of the data, such as an indication of the segmentation of the data (i.e., the segmentation state). The resources allocated by the second RA trigger frame 213 are sufficient 216 for transmission of the second segment 208 of the data.

FIG. 2B shows another example of a call-flow for a procedure for segmented data transmission, in accordance with an embodiment of the present disclosure. In this example, an AMP STA 201 has obtained data 202, such as by collecting data using integrated sensors, that is stored in memory 203 integral to the AMP STA 201 and that is to be transmitted to an AP 204. The AP 204 may be a node of a communications network, through which the data 202 may be sent for delivery to a receiving network entity. Initially, the AMP STA 201 has sufficient energy stored 217 for sending all of the data 202 to the AP 204 in a single transmission. The AMP STA 201 may have harvested energy available in its surroundings. The amount of energy stored at the AMP STA 201 may be provided through an energy parameter and may indicate an energy state for the AMP STA 201. The AP 204 may send a first RA trigger frame 206 to the AMP STA 201 that indicates which resources may be allocated to the AMP STA 201 for transmission of its data 202 and for how long they may be allocated. This initial resource allocation may, for example, be a timeslot. In this example, the resources allocated to the AMP STA 201, particularly their duration, are insufficient 218 for transmitting all the data 202. Because the allocated resources are insufficient, the AMP STA 201 may divide the data 202 into a plurality of segments. In this example, the AMP STA 201 divides the data 202 into a first segment and a second segment. In accordance with the first RA allocation trigger frame 206, the AMP STA 201 may send the first segment 208 of the data to the AP 204, which may free up 209 space in the memory 203 of the AMP STA 201. The AMP STA 201 may include information with the first segment 208 of the data, such as an indication of the energy state of the AMP STA 201 and an indication of the segmentation of the data (i.e., the segmentation state). The segmentation state may inform the AP 204 that data remains at the AMP STA 201. The AMP STA 201 may then harvest 210 more energy to prepare for transmission of the remaining data 211, i.e., the second segment. The AP 204 may, based on the received information on the energy state of the AMP STA 201, wait for the AMP STA 201 to harvest sufficient energy 212 for a subsequent transmission. Based on the received information on the segmentation of the data and on the energy state of the AMP STA 201, the AP 204 may send a second RA trigger frame 213 to the AMP STA 201 that indicates a further resource allocation for transmission of the second segment of the data, wherein the further resource allocation is greater than the initial resource allocation. For example, the further resource allocation may have a timeslot with a longer duration than that of the initial resource allocation. In accordance with the second RA allocation trigger frame 213, the AMP STA 201 may send the second segment 214 of the data to the AP 204, which may further free up 215 space in the memory 203 of the AMP STA 201. The AMP STA 201 may include information with the second segment 208 of the data, such as an indication of the segmentation of the data (i.e., the segmentation state). The resources allocated by the second RA trigger frame 213 are sufficient 216 for transmission of the second segment 208 of the data.

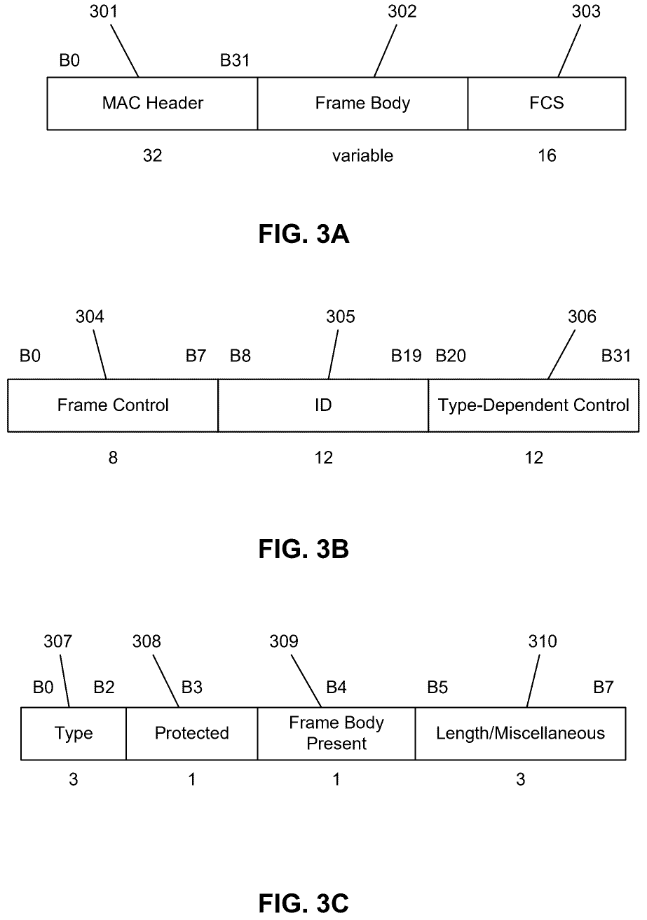

In embodiments of the present disclosure, data frames sent by an AMP STA 201 may be formatted according to the WUR frame format and information on the energy and segmentation states of the AMP STA 201 may be included in the frame header. FIGS. 3A, 3B, and 3C show examples of a WUR frame and its header, in accordance with embodiments of the present disclosure.

FIG. 3A shows an example format for a WUR frame, in accordance with an embodiment of the present disclosure. The frame may comprise the following fields: a MAC header 301; a frame body 302, which may include data or segments thereof; and a frame check sequence (FCS) field 303. In FIG. 3A the number of bits in each field is indicated below the respective field, and bits delineating each field are shown above the respective field. The MAC header 301 may comprise 32 bits (i.e., from bit B0 to bit B31), the frame body 302 may comprise a variable number of bits, and the FCS field may comprise 16 bits.

FIG. 3B shows an example format for a MAC header 301, in accordance with an embodiment of the present disclosure. The MAC header 301 may comprise the following fields: a frame control field 304; an identification (ID) field 305; and a type-dependent control field 306, which may be used to indicated information on the energy and segmentation states of the AMP STA 201 as well as any other control information. In FIG. 3B the number of bits in each field is indicated below the respective field, and bits delineating each field are shown above the respective field. The frame control field 304 may comprise eight bits (i.e., from B0 to bit B7), the ID field 305 may comprise 12 bits (i.e., from bit B8 to bit B19), and the type-dependent control field 306 may comprise 12 bits (i.e., from bit B20 to bit B31).

FIG. 3C shows an example format for a frame control field 304, in accordance with an embodiment of the present disclosure. The frame control field 304 may comprise the following subfields: a type subfield 307, a protected subfield 308, a frame body present subfield 309, and a length or miscellaneous subfield 310. In FIG. 3C the number of bits in each subfield is indicated below the respective subfield, and bits delineating each subfield are shown above the respective subfield. The type subfield 307 may comprise three bits (i.e., from bit B0 to bit B2), the protected subfield 308 may comprise one bit (i.e., bit B3), the frame body present subfield 309 may comprise one bit (i.e., bit B4), and the length or miscellaneous subfield may comprise three bits (i.e., from bit B5 to bit B7). The type subfield 307 may be set to a particular value to indicate that the information in the type-dependent control field 306 in the MAC header 301 pertains to communications from an AMP STA 201. The type subfield 307 may be configured according to the settings presented in Table 1, shown below.

TABLE 1
Settings for the type subfield of a WUR frame.

| Type Setting Value | Type Description |
|---|---|
| 0 | WUR beacon |
| 1 | WUR wake-up |
| 2 | WUR vendor-specific |
| 3 | WUR discovery |
| 4 | WUR short wake-up |
| 5 to 7 | AMP communications |

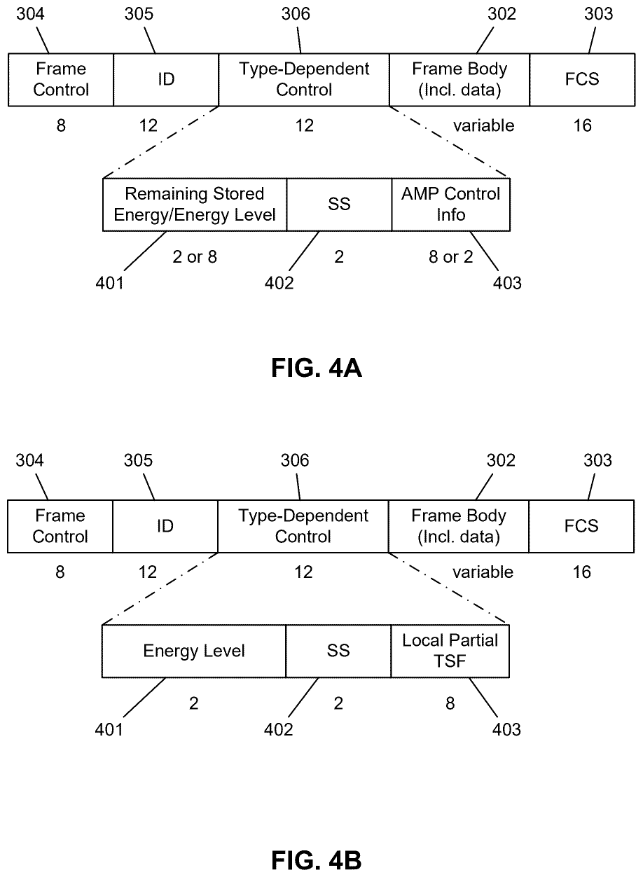

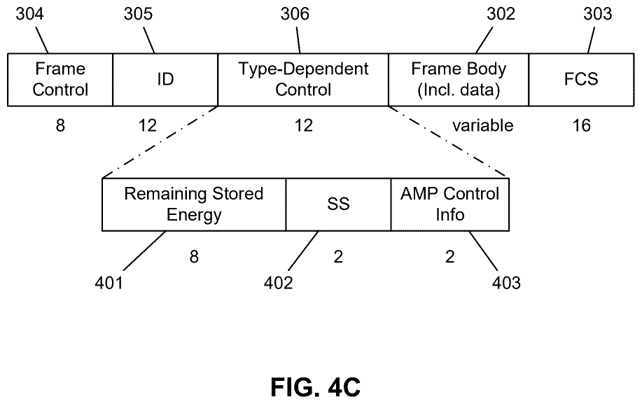

FIG. 4A shows an example format for a WUR frame in accordance with an embodiment of the present disclosure. Similar to FIGS. 3A and 3B, the WUR frame shown in FIG. 4A comprises: a MAC header 301 including a frame control field 304, an ID field 305, and a type-dependent control field 306; a frame body 302, which may include data or a data segment; and a FCS field 303. A type subfield 307 in the type-dependent control field 306 may be set to an AMP communication type, according to Table 1. The ID field 305 may include an identifier for the AMP STA 201. An identifier for a destination for the WUR frame may be included in the frame body 302, such as by using the first 12 of 16 bits of a user information field. In the present example, the type-dependent control field 306 may comprise a remaining stored energy (or energy level) subfield 401, a segmentation status (SS) subfield 402, and an AMP control information subfield 403. In FIG. 4A the number of bits in each field or subfield is indicated below the respective field or subfield. The remaining stored energy subfield 401 may comprise two or eight bits, the SS subfield 402 may comprise two bits, and the AMP control information subfield 403 may comprise the remaining bits of the type-dependent field 306 (i.e., eight or two bits). The remaining stored energy subfield 401 may be set to indicate the energy state of the AMP STA 201 and the SS subfield 402 may be set to indicate the segmentation state of the data at the AMP STA 201, such as whether it has been divided and which segment of the data is included with the WUR frame.

FIG. 4B shows an example format for a WUR frame configured according to that of FIG. 4A and to an embodiment of the present disclosure. In this example, the remaining stored energy subfield 401 is configured as an energy level subfield 401 and comprises two bits. The AMP control information subfield 403 accordingly comprises eight bits. The energy level subfield 401 may be configured such that setting it to the values of 0, 1, 2, or 3 may indicate different energy levels for the AMP STA 201. For example, a value of 0 may indicate a high energy level, a value of 1 may indicate a moderate or alert energy level, a value of 2 may indicate a low energy level, and a value of 3 may be reserved. The AMP control information subfield 403 may be configured to provide the local partial TSF for the AMP STA 201.

FIG. 4C shows another example format for a WUR frame configured according to that of FIG. 4A and to an embodiment of the present disclosure. In this example, the remaining stored energy subfield 401 comprises eight bits. The AMP control information subfield 403 accordingly comprises two bits. The remaining stored energy subfield 401 may be configured such that it may be set to indicate an amount of energy available for the AMP STA 201. For example, the remaining stored energy subfield 401 may be set to indicate a percentage of energy remaining at the AMP STA 201 or an absolute measure of the energy remaining at the AMP STA 201, such as an amount of microjoules.

In embodiments, a correction factor may be applied to the information on the energy state of the AMP STA 201 in anticipation of energy that may be consumed from transmitting the data or data segment. In other words, the energy state may be modified in accordance with a correction factor for anticipated transmission consumption. The correction factor may be pre-determined and applied by the by the AP 204 upon receipt of the information in the remaining stored energy subfield 401. Alternatively, the correction factor may be pre-determined and applied by the AMP STA 201 prior to sending the WUR frame, when the AMP STA 201 prepares the WUR frame. The correction factor may, for example, by an amount that is deducted from a percentage or absolute measure of energy remaining at the AMP STA 201.

In embodiments, such as those described in relation to FIGS. 4A, 4B, and 4C, the SS subfield 402 may be set according to Table 2 shown below. The SS subfield 402 may be set by the AMP STA 201 to indicate to the AP 204 that all data is included in the WUR frame (i.e., the data has not been divided into segments), that a first (or initial) segment of the data is included in the WUR frame, or that a final (or last) segment of the data is included in the WUR frame.

TABLE 2
Examples of a two-bit segmentation status.

| SS Subfield | Segmentation Interpretation |
|---|---|
| 00 | All bits included (no segmentation) |
| 01 | First segment included |
| 10 | Reserved |
| 11 | Final segment included |

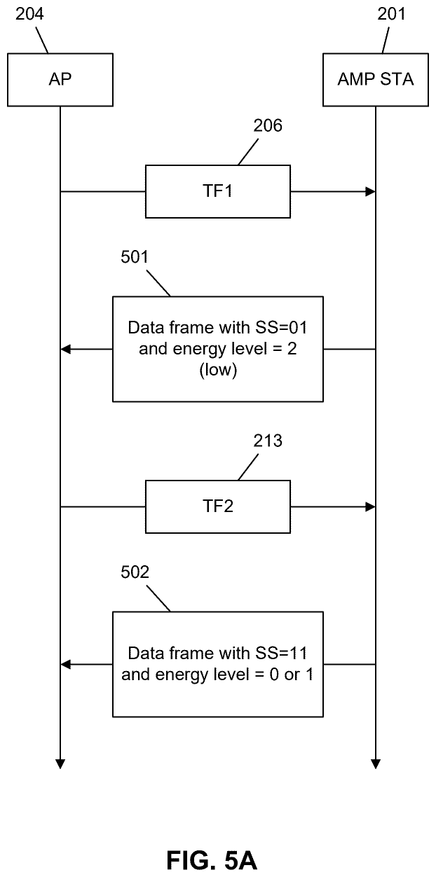

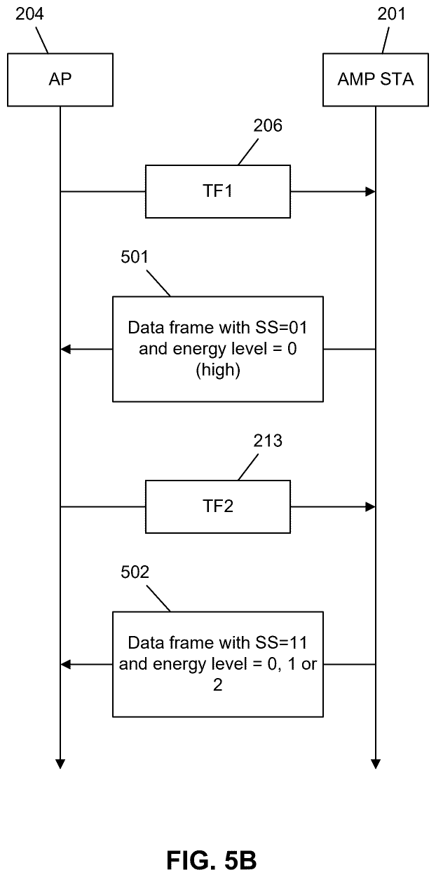

FIG. 5A shows an example of a call-flow between an AMP STA 201 and an AP 204 using WUR frames, in accordance with an embodiment of the present disclosure. In this example, the WUR frames may be formatted according to the configurations described in relation to FIG. 4B and Table 2. The AMP STA 201 has data that is to be transmitted to the AP 204. The AP 204 may send a first trigger frame (TF1) 206 to the AMP STA 201 allocating resources to the AMP STA 201 for transmission of its data. The AMP STA 201 may have insufficient energy stored to transmit all the data at once and so may divide the data into a first segment and a second segment. The AMP STA 201 may send a first WUR frame 501 including the first segment to the AP 204. The remaining stored energy subfield 401 of the first WUR frame 501 may be configured as an energy level subfield 401 and may comprise two bits, which may be set to a value of two in accordance with the energy state of the AMP STA 201 to indicate that the remaining stored energy of the AMP STA 201 is ‘low’. The SS subfield 402 may be set to 01, in accordance with Table 2 and the segmentation state of the first segment of the data, to indicate that the segment of data included with the first WUR frame 501 is a first segment of data. The AP 204 may receive this information when it receives the first WUR frame 501. The AP 204 may determine that the AMP STA did not have sufficient energy for sending all its data, based on the energy state and segmentation state of the AMP STA 201, as indicated respectively by the energy level subfield 401 and the SS subfield 402. The AP 204 may then a second TF2 213 to the AMP STA 201 allocating resources to the AMP STA 201 for transmission of the second segment of the data. The AMP STA 201 may send a second WUR frame 502 including the second segment to the AP 204. The remaining stored energy subfield 401 of the second WUR frame 501 may again be configured as an energy level subfield 401 and may again comprise two bits, which may be set to a value of zero or one in accordance with the energy state of the AMP STA 201 to indicate that the remaining stored energy of the AMP STA 201 is now ‘high’ or ‘moderate’, respectively. The SS subfield 402 may be set to 11, in accordance with Table 2 and the segmentation state of the second segment of the data, to indicate that the segment of data included with the second WUR frame 501 is a final segment of data.

FIG. 5B shows an example of a call-flow between an AMP STA 201 and an AP 204 using WUR frames, in accordance with an embodiment of the present disclosure. In this example, the WUR frames may be formatted according to the configurations described in relation to FIG. 4B and Table 2. The AMP STA 201 has data that is to be transmitted to the AP 204. The AP 204 may send a first trigger frame (TF1) 206 to the AMP STA 201 allocating resources to the AMP STA 201 for transmission of its data. The AMP STA 201 may have sufficient energy stored to transmit all the data at once but may not have been allocated enough resources to do so; therefore, the AMP STA 201 may divide the data into a first segment and a second segment. The AMP STA 201 may send a first WUR frame 501 including the first segment to the AP 204. The remaining stored energy subfield 401 of the first WUR frame 501 may be configured as an energy level subfield 401 and may comprise two bits, which may be set to a value of zero in accordance with the energy state of the AMP STA 201 to indicate that the remaining stored energy of the AMP STA 201 is ‘high’. The SS subfield 402 may be set to 01, in accordance with Table 2 and the segmentation state of the first segment of the data, to indicate that the segment of data included with the first WUR frame 501 is a first segment of data. The AP 204 may receive this information when it receives the first WUR frame 501. The AP 204 may determine that the AMP STA did not have sufficient resources allocated to it for sending all its data, based on the energy state and segmentation state of the AMP STA 201, as indicated respectively by the energy level subfield 401 and the SS subfield 402. The AP 204 may then a second TF2 213 to the AMP STA 201 allocating resources to the AMP STA 201 for transmission of the second segment of the data. The AMP STA 201 may send a second WUR frame 502 including the second segment to the AP 204. The remaining stored energy subfield 401 of the second WUR frame 501 may again be configured as an energy level subfield 401 and may again comprise two bits, which may be set to a value of zero, one or two in accordance with the energy state of the AMP STA 201 to indicate that the remaining stored energy of the AMP STA 201 is now ‘high’, ‘moderate’, or ‘low’, respectively. The SS subfield 402 may be set to 11, in accordance with Table 2 and the segmentation state of the second segment of the data, to indicate that the segment of data included with the second WUR frame 501 is a final segment of data.

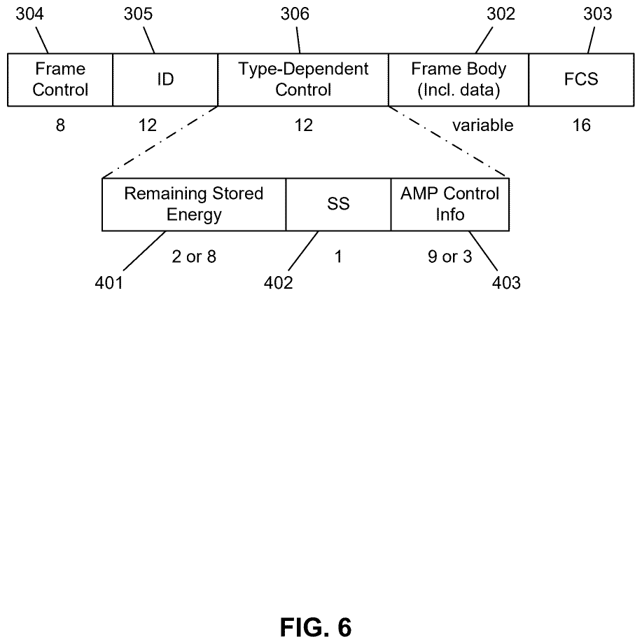

FIG. 6 shows an example format for a WUR frame in accordance with another embodiment of the present disclosure. Similar to FIGS. 3A and 3B, the WUR frame shown in FIG. 6 comprises: a MAC header 301 including a frame control field 304, an ID field 305, and a type-dependent control field 306; a frame body 302, which may include data or a data segment; and a FCS field 303. A type subfield 307 in the type-dependent control field 306 may be set to an AMP communication type, according to Table 1. The ID field 305 may include an identifier for the AMP STA 201. An identifier for a destination for the WUR frame may be included in the frame body 302, such as by using the first 12 of 16 bits of a user information field. In the present example, the type-dependent control field 306 may comprise a remaining stored energy (or energy level) subfield 401, a SS subfield 402, and an AMP control information subfield 403. In FIG. 6 the number of bits in each field or subfield is indicated below the respective field or subfield. The remaining stored energy subfield 401 may comprise two or eight bits, the SS subfield 402 may comprise one bit, and the AMP control information subfield 403 may comprise the remaining bits of the type-dependent field 306 (i.e., nine or three bits). The remaining stored energy subfield 401 may be set to indicate the energy state of the AMP STA 201 and the SS subfield 402 may be set to indicate the segmentation state of the data at the AMP STA 201. The SS subfield 402 may, for example, be set according to Table 3 shown below. The SS subfield 402 may be set by the AMP STA 201 to indicate to the AP 204 that all remaining data is included in the WUR frame (i.e., the data has not been divided into segments or that no segments remain), or that a first (or initial) segment of the data is included in the WUR frame (and that a second segment remains). When nine bits remain for the AMP control information subfield 403, the first eight bits may be set to indicate the local partial TSF and the remaining one bit may be used to provide additional information.

TABLE 3
Examples of a one-bit segmentation status.

| SS Subfield | Segmentation Interpretation |
|---|---|
| 0 | No segmentation of data or no remaining segments |
| 1 | First of two segments included |

In some embodiments of the present disclosure, an AMP STA 201 may divide its data into N data segments, where N is any natural number. In these embodiments, the size of a data segment presently being sent to an AP 204 may be limited according to the current energy state of the AMP STA 201 or currently available resources allocated by the AP 204. The respective size of each subsequent segment may match that of a previous segment or may be determined according to the energy state of the AMP STA 201 or the allocated resources at the respective time of transmission. Table 4 shown below provides settings for the SS subfield 402 for a division of the data into N segments, when two bits are used to represent the SS state, such as in the WUR frames of FIGS. 4A, 4B, and 4C. The SS subfield 402 may be set by the AMP STA 201 to indicate to the AP 204 that all data is included in the WUR frame (i.e., the data has not been divided into segments), that a first (or initial) segment of the data is included in the WUR frame, that a final (or last) segment of the data is included in the WUR frame, or that an intermediate (i.e., between the first and final) segment of the data is included in the WUR frame.

TABLE 4
Examples of a two-bit segmentation status for N segments.

| SS Subfield | Segmentation Interpretation |
|---|---|
| 00 | All bits included (no segmentation) |
| 01 | First segment included |
| 10 | Segment included other than the first or last ones |
| 11 | Last segment included |

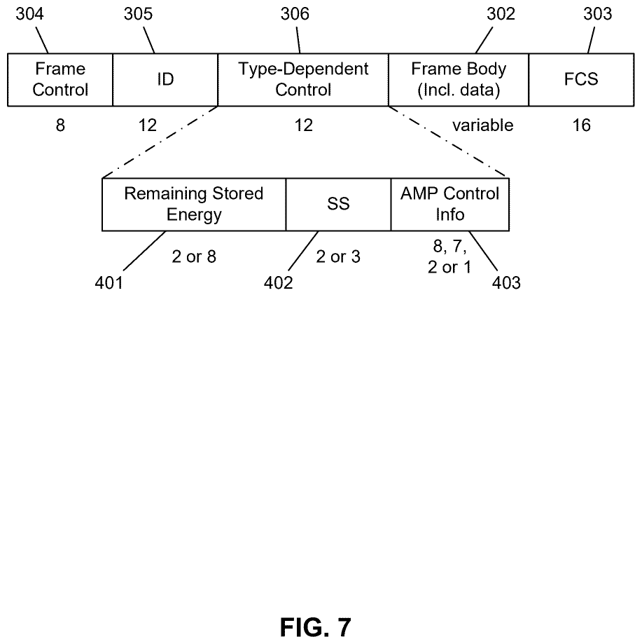

In some embodiments, wherein an AMP STA 201 divides its data into N segments, SS subfield 402 may be used to indicate a respective sequential position of each segment. This information may be included so that an AP 204 can verify that the segments that it receives belong to the same data. In these embodiments, the WUR frame may be SS subfield 402 may comprise two or three bits. FIG. 7 shows an example format for a WUR frame in accordance with an embodiment of the present disclosure wherein the respective sequential position of a segment may be indicated. Similar to FIGS. 3A and 3B, the WUR frame shown in FIG. 7 comprises: a MAC header 301 including a frame control field 304, an ID field 305, and a type-dependent control field 306; a frame body 302, which may include data or a data segment; and a FCS field 303. The type-dependent control field 306 may comprise a remaining stored energy (or energy level) subfield 401, a SS subfield 402, and an AMP control information subfield 403. In FIG. 7 the number of bits in each field or subfield is indicated below the respective field or subfield. The remaining stored energy subfield 401 may comprise two or eight bits, the SS subfield 402 may comprise two or three bits, and the AMP control information subfield 403 may comprise the remaining bits of the type-dependent field 306 (i.e., eight, seven, two or one bits). The remaining stored energy subfield 401 may be set to indicate the energy state of the AMP STA 201 and the SS subfield 402 may be set to indicate the segmentation state of the data at the AMP STA 201. When the SS subfield 402 comprises two bits and when the data is divided into a maximum of three segments, the SS subfield 402 may, for example, be set according to Table 5 shown below. The SS subfield 402 may be set by the AMP STA 201 to indicate to the AP 204 that all remaining data is included in the WUR frame (i.e., the data has not been divided into segments or that no segments remain), that a first (or initial) segment of the data is included in the WUR frame, that a second segment of the data is included in the WUR frame, or that a final segment of the data is included in the WUR frame. Alternatively, when the SS subfield 402 comprises three bits and when the data is divided into a maximum of six segments, the SS subfield 402 may, for example, be set according to Table 6 shown below. The SS subfield 402 may be set by the AMP STA 201 to indicate to the AP 204 that all remaining data is included in the WUR frame (i.e., the data has not been divided into segments or that no segments remain), that a first (or initial) segment of the data is included in the WUR frame, that a intermediate segment of the data (e.g., a second, third, fourth, or fifth segment) is included in the WUR frame, or that a final segment of the data (e.g., a sixth segment) is included in the WUR frame.

TABLE 5
Examples of a two-bit segmentation status for
N segments with sequential positions indicated.

| SS Subfield Value | Segmentation Interpretation |
|---|---|
| 0 | All bits included (no segmentation) |
| 1 | First segment included |
| 2 | Second segment included |
| 3 | Last segment included |

TABLE 6
Examples of a three-bit segmentation status for
N segments with sequential positions indicated.

| SS Subfield Value | Segmentation Interpretation |
|---|---|
| 0 | All bits included (no segmentation) |
| 1 | First segment included |
| 2 to 6 | Second segment included |
| 7 | Last segment included |

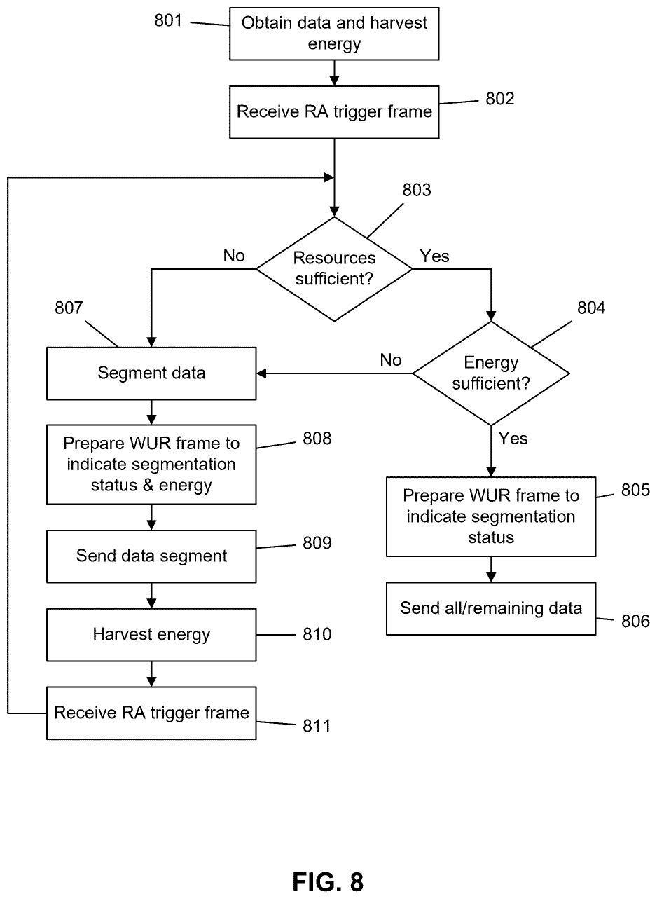

FIG. 8 shows a flowchart of a method for an AMP STA 201 to segment data, in accordance with an embodiment of the present disclosure. The AMP STA 201 may be communicatively connected to an AP 204 of a communications network. At action 801, the AMP STA 201 may obtain data, such as by collecting it through the use of integrated sensors, and may harvest energy from surrounding power sources, such as thermal, vibrational, and solar power sources. The AMP STA 201 may generate electrical power from the energy that it harvests and use the electrical power towards the transmission of data. The AMP STA 201 may store the data in integrated memory 203 and may store the harvest power. At action 802, the AMP STA 201 may receive an initial trigger frame from the AP 204 that indicates a resource allocation for transmitting data to the AP 204. At action 803, the AMP STA 201 may determine whether the allocated resources are sufficient for transmitting all its data. Sufficiency of the allocated resources may be determined by comparing the allocated resources to a pre-determined threshold. At action 804, the AMP STA 201 may obtain an energy parameter indicating an energy state for the AMP STA 201 and determine, in accordance with the energy state, whether it has sufficient energy for transmitting all its data. Sufficiency of the energy state may be determined by comparing the energy state to a pre-determined threshold. If the AMP STA 201 determines that the allocated resources are sufficient and that its energy state is sufficient, then the AMP STA 201 may prepare, at action 805, a WUR frame including all its data, such as in a frame body 302. The WUR frame may further indicate that there has been no segmentation of the data, such as through a SS subfield 402 of a type-dependent control field 306 in the WUR frame. The WUR frame may be configured according to that shown in any of FIGS. 4A, 4B, 4C, 6, and 7. At action 806, the AMP STA 201 may send, in accordance with the resource allocation, the WUR frame including all its data. Alternatively, if the AMP STA 201 determines that the allocated resources are insufficient or that its energy state is insufficient, then the AMP STA 201 may divide, at action 807, the data into a plurality of segments according to its energy state and the resource allocation. The data may be integrated into a first and a last segment, or N segments. At action 808, the AMP STA 201 may prepare a WUR frame including one segment of the data, such as in a frame body 302. The WUR frame may further indicate, such as through a SS subfield 402, that only a segment of the data is included in the WUR frame. The WUR frame may be configured according to that shown in any of FIGS. 4A, 4B, 4C, 6, and 7. At action 809, the AMP STA 201 may send, in accordance with the resource allocation, the WUR frame including the segment of the data. The AMP STA 201 may then, at action 810, harvest additional energy for transmission of the remaining segments of data. At action 811, the AMP STA 201 may receive another trigger frame from the AP 204 that indicates a further resource allocation for transmitting data to the AP 204. Actions 803 to 811 may be repeated until all remaining data is sent from the AMP STA 201 to the AP 204.

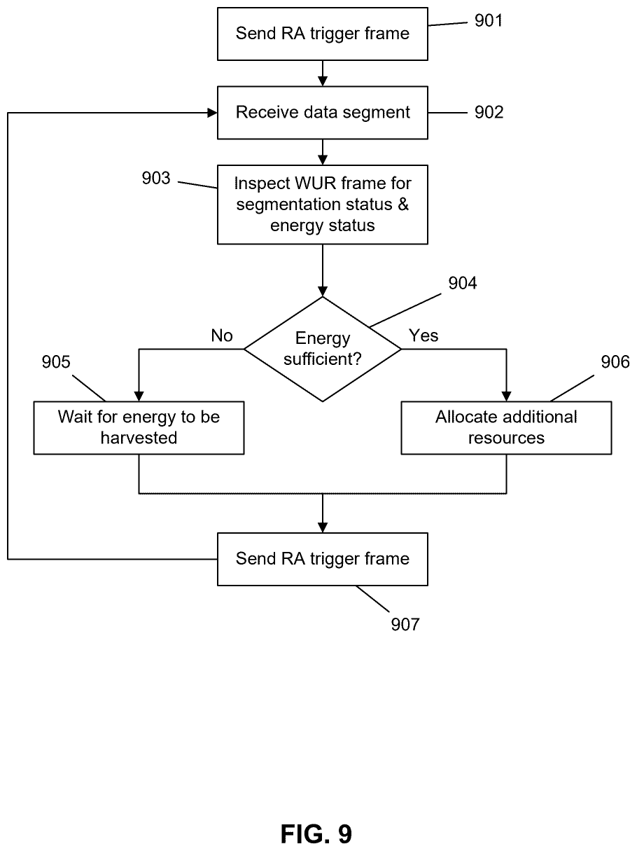

FIG. 9 shows a flowchart of a method for an AP 204 to allocate additional resources for transmission of segmented data from an AMP STA 201, in accordance with an embodiment of the present disclosure. At action 901, the AP 204 may send to the AMP STA 201 an initial trigger frame with a resource allocation for transmission of data from the AMP STA 201. At action 902, the AP 204 may receive from the AMP STA 201 a WUR frame, in accordance with the resource allocation. The WUR frame may be configured according to that shown in any of FIGS. 4A, 4B, 4C, 6, and 7. At action 903, the AP 204 may inspect the WUR frame for a segmentation status and an energy status for the AMP STA 201. The segmentation status may indicate that a further one or more segments of the data remains at the AMP STA 201. At action 904, the AP 204 may determine, in accordance with the energy status for the AMP STA 201 and a pre-determined threshold for the energy state, whether the AMP STA 201 had sufficient energy to transmit all its data at once. If the AMP STA 201 was determined to have had insufficient energy, the AP 204 may wait, at action 905, for the AMP STA 201 to harvest additional energy for transmission of the remaining one or more segments of the data. The AP 204 may wait for a pre-determined period of time. Alternatively, if the AMP STA 201 was determined to have had sufficient energy, the AP 204 may allocate, at action 906, additional resources to the AMP STA 201 for transmission of the remaining one or more segments of the data. At action 907, the AP 204 may send a further trigger frame with a new allocation of resources for transmission of the remaining one or more segments of the data. The new allocation, if additional resources have been allocated, may be greater than the allocation of the initial trigger frame. Actions 902 to 907 may be repeated until all remaining data is sent from the AMP STA 201 to the AP 204.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

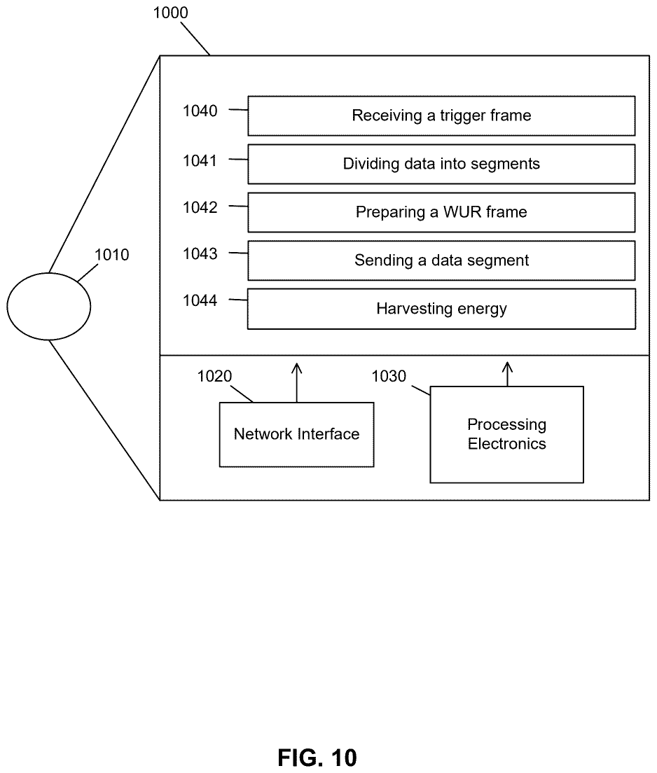

FIG. 10 shows an apparatus 1000 for segmented data transmission, according to embodiments of the present disclosure. The apparatus 1000 may be located at a node 1010 of a network. The apparatus may include a network interface 1020 and processing electronics 1030. The processing electronics 1030 may include a computer processor executing program instructions stored in memory, or other electronics components such as digital circuitry, including for example FPGAs and ASICs. The network interface 1020 may include an optical communication interface or radio communication interface, such as a transmitter and receiver. The apparatus 1000 may include several functional components, each of which may be partially or fully implemented using the underlying network interface 1020 and processing electronics 1030. Examples of functional components may include modules for receiving 1040 a trigger frame, dividing 1041 data into segments, preparing 1042 a WUR frame, sending 1043 a data segment, and harvesting 1044 energy.

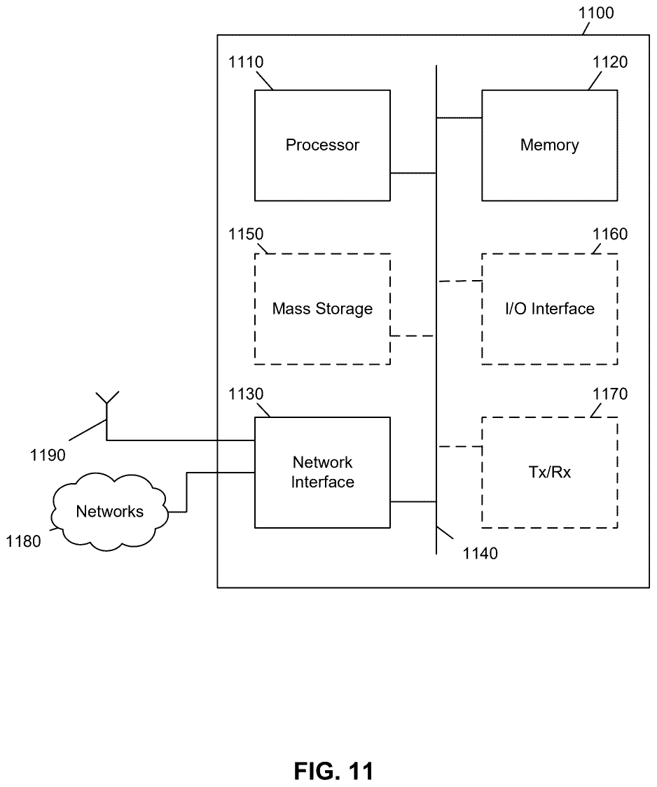

FIG. 11 shows a schematic diagram of an electronic device 1100 that may perform any or all of the operations of the above methods and features explicitly or implicitly described herein, according to different embodiments of the present disclosure. For example, a computer equipped with network function may be configured as electronic device 1100. The electronic device 1100 may be used to implement the apparatus 1000 of FIG. 10, for example. The electronic device 1100 may further be used as part of an AMP STA 201 or an AP 204, for example.

As shown, the electronic device 1100 may include a processor 1110, such as a Central Processing Unit (CPU) or specialized processors such as a Graphics Processing Unit (GPU) or other such processor unit, memory 1120, network interface 1130, and a bi-directional bus 1140 to communicatively couple the components of electronic device 1100. Electronic device 1100 may also optionally include non-transitory mass storage 1150, an I/O interface 1160, and a transceiver 1170. According to certain embodiments, any or all of the depicted elements may be utilized, or only a subset of the elements. Further, the electronic device 1100 may contain multiple instances of certain elements, such as multiple processors, memories, or transceivers. Also, elements of the hardware device may be directly coupled to other elements without the bi-directional bus 1140. Additionally or alternatively to a processor and memory, other electronics, such as integrated circuits, may be employed for performing the required logical operations.

The memory 1120 may include any type of tangible, non-transitory memory such as static random access memory (SRAM), dynamic random access memory (DRAM), synchronous DRAM (SDRAM), read-only memory (ROM), any combination of such, or the like. The mass storage element 1150 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 1120 or mass storage 1150 may have recorded thereon statements and instructions executable by the processor 1110 for performing any of the aforementioned method operations described above. The memory 1120 may be configured to perform the functions of an AMP STA memory 203.

Network interface 1130 may include at least one of a wired network interface and a wireless network interface. The network interface 1130 may include a wired network interface to connect to a communication network 1180 and may also include a radio access network interface 1190 for connecting to the communication network 1180 or other network elements over a radio link. The network interface 1130 may enable the electronic device 1100 to communicate with remote entities such as those connected to the communication network 1180.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for transmitting data from a station to an access point (AP) of a communications network, the method comprising, at the station:
receiving, from the AP, a first trigger frame indicating a first resource allocation for the station;
obtaining an energy parameter indicating an energy state for the station;
dividing, in accordance with the first resource allocation and the energy state for the station, the data into a plurality of segments;
sending, to the AP, a first segment of the plurality of segments of the data in accordance with the first resource allocation;
receiving, from the AP, a second trigger frame indicating a second resource allocation for the station;
and
sending, to the AP, a second segment of the plurality of segments of the data in accordance with the first resource allocation.

2. The method of claim 1 wherein dividing, in accordance with the first resource allocation and the energy state for the station, the data into the plurality of segments of the data includes:
segmenting, when the first resource allocation is less than a threshold allocation or when the energy state is less than a threshold energy state, the data into the plurality of segments of the data.

3. The method of claim 1 wherein:
the method further comprises, at the station:
preparing a wake-up radio (WUR) frame including the first segment of the plurality of segments of the data and a medium access control (MAC) header, the MAC header including a type-dependent control field indicating the energy state and a segmentation state for the first segment of the plurality of segments of the data;
and
sending, to the AP, the first segment of the plurality of segments of the data in accordance with the first resource allocation includes:
sending, to the AP, the WUR frame in accordance with the first resource allocation.

4. The method of claim 3 wherein:
the method further comprises, at the station:
preparing a further WUR frame including the second segment of the plurality of segments of the data and a further MAC header, the further MAC header including a further type-dependent control field indicating a further segmentation state for the second segment of the plurality of segments of the data;
and
sending, to the AP, the second segment of the plurality of segments of the data in accordance with the second resource allocation includes:
sending, to the AP, the further WUR frame in accordance with the second resource allocation.

5. The method of claim 4 wherein:
the type-dependent control field includes a first set of bits and a second set of bits;
the further type-dependent control field includes a third set of bits;
preparing the WUR frame includes:
setting the first set of bits to indicate the energy state;
and
setting the second set of bits to indicate the segmentation state;
and
preparing the further WUR frame includes:
setting the third set of bits to indicate the further segmentation state.

6. The method of claim 5 wherein:
the first set of bits includes two bits;
and
setting the first set of bits to indicate the energy state includes:
setting the two bits to indicate an energy level.

7. The method of claim 5 wherein:
the first set of bits includes eight bits;
and
setting the first set of bits to indicate the energy state includes:
setting the eight bits to indicate either a remaining energy percentage or a remaining energy measure.

8. The method of claim 5 wherein:
each of the second set of bits and the third set of bits includes a respective two bits;
setting the second set of bits to indicate the segmentation state includes:
setting the respective two bits of the second set of bits to indicate segmentation of the data and that the first segment of the plurality of segments of the data is an initial segment;
and
setting the third set of bits to indicate the further segmentation state includes:
setting the respective two bits of the third set of bits to indicate segmentation of the data and that the second segment of the plurality of segments of the data is a final segment.

9. The method of claim 5 wherein:
each of the second set of bits and the third set of bits includes a respective one bit;
setting the second set of bits to indicate the segmentation state includes:
setting the respective one bit of the second set of bits to indicate at least one segment of the plurality of segments of the data remains;
and
setting the third set of bits to indicate the further segmentation state includes:
setting the respective one bit of the third set of bits to indicate that all segments of the plurality of segments of the data are sent.

10. The method of claim 5 wherein:
the plurality of segments of the data includes at least three segments of the data;
each of the second set of bits and the third set of bits includes a respective two bits;
setting the second set of bits to indicate the segmentation state includes:
setting the respective two bits of the second set of bits to indicate segmentation of the data and that the first segment of the plurality of segments of the data is an initial segment;
and
setting the third set of bits to indicate the further segmentation state includes:
setting the respective two bits of the third set of bits to indicate segmentation of the data and that at least one segment of the plurality of segments of the data remains.

11. The method of claim 5 wherein:
the plurality of segments of the data includes at least three segments of the data;
each of the second set of bits and the third set of bits includes a respective three bits;
setting the second set of bits to indicate the segmentation state includes:
setting the respective three bits of the second set of bits to indicate a respective sequential position for the first segment of the plurality of segments of the data;
and
setting the third set of bits to indicate the further segmentation state includes:
setting the respective three bits of the third set of bits to indicate a respective sequential position for the second segment of the plurality of segments of the data.

12. The method of claim 5 wherein:
the type-dependent control field further includes a fourth set of bits;
and
preparing the WUR frame further includes:
setting the fourth set of bits to indicate a local partial time synchronization function.

13. The method of claim 12 further comprising, at the station:
receiving, from the AP, a beacon frame;
and
adjusting, in accordance with the beacon frame, a clock for the station.

14. The method of claim 5 wherein setting the first set of bits to indicate the energy state includes:
modifying the energy state in accordance with a correction factor for anticipated transmission consumption.

15. The method of claim 1 further comprising, at the station:
collecting, by one or more sensors, the data.

16. The method of claim 1 wherein:
the method further comprises, at the station:
generating, from one or more power sources, electrical power;
and
sending, to the AP, the first segment of the plurality of segments of the data in accordance with the first resource allocation includes:
sending, to the AP using the electrical power, the first segment of the plurality of segments of the data in accordance with the first resource allocation.

17. The method of claim 1 wherein:
the method further comprises, at the station:
generating, from one or more power sources, electrical power;
and
sending, to the AP, the second segment of the plurality of segments of the data in accordance with the second resource allocation includes:
sending, to the AP using the electrical power, the second segment of the plurality of segments of the data in accordance with the second resource allocation.

18. A method for transmitting data from a station to a network access point (AP), the method comprising, at the AP:
sending, to the station, a first trigger frame indicating a first resource allocation for the station;
receiving, from the station in accordance with the first resource allocation, a first wake-up radio (WUR) frame including a first segment of the data and a medium access control (MAC) header, the MAC header including a type-dependent control field indicating, for the station, an energy state and a segmentation state for the first segment of the data, the segmentation state indicating a second segment of the data;
sending, to the station and in accordance with the segmentation state for the first segment of the data, a second trigger frame indicating a second resource allocation for the station, the second resource allocation greater than the first resource allocation when the energy state exceeds a threshold energy state;
and
receiving, from the station in accordance with the second resource allocation, a second WUR frame including the second segment of the data.

19. The method of claim 18 wherein sending, to the station, the second trigger frame includes:
sending, to the station, the second trigger frame after a time period, the time period in accordance with the energy state for the station.

20. An electronic device comprising a processor coupled to tangible, non-transitory processor-readable memory, the memory having recorded thereon data and instructions to be executed by the processor to implement a method comprising:
receiving, from an access point (AP), a first trigger frame indicating a first resource allocation for the electronic device;
obtaining an energy parameter indicating an energy state for the electronic device;
dividing, in accordance with the first resource allocation and the energy state for the electronic device, the data into a plurality of segments;
sending, to the AP, a first segment of the plurality of segments of the data in accordance with the first resource allocation;
receiving, from the AP, a second trigger frame indicating a second resource allocation for the electronic;
and
sending, to the AP, a second segment of the plurality of segments of the data in accordance with the second resource allocation.
